(19) United States
(12) Patent Application Publication
(10) Pub. No.: US 2007/0005742 A1
(43) Pub. Date: Jan. 4, 2007

(54) Efficient network communications via directed processor interrupts

(76) Inventors: Avigdor Eldar, Jerusalem (IL); Avraham Mualem, Jerusalem (IL); Patrick L. Connor, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/172,741

(22) Filed: Jun. 30, 2005

(51) Int. Cl. G06F 15/173

(52) U.S. Cl. 709/223

(57) ABSTRACT

A method of receiving packets over a network interface and queuing the packets onto a receive queue containing packets to be processed by more than one processor is described. The method includes selecting a particular one of the processors to interrupt when the receive queue is to be processed. Related systems and methods are also described and claimed.

### FIELD OF THE INVENTION

Embodiments of the invention relate to network communications. In particular, embodiments of the invention can improve performance of network communications between systems.

### BACKGROUND

Applications for contemporary computing systems often make extensive use of network communication facilities to exchange data with other, cooperating applications that may be executing on remote machines. Network communications rely on services provided by a range of subsystems, including both hardware and software. For example, data transfer occurs over a wired or wireless physical medium such as Ethernet, Token Ring, or Wi-Fi. An end system typically uses a network interface card (“NIC”) or other equivalent hardware to produce and interpret the signals appropriate for the physical medium. Low-level driver software configures and manages the operation of a NIC, so that a system can exchange individual data packets with its communication partners. Higher-level protocol-handling functions, often provided by the system's operating system (“OS”), may aggregate the individual data packets into a data communication protocol, so that an application need not concern itself with data transmission problems such as lost, fragmented, corrupted or duplicated data packets. The hardware, driver, and protocol-handling software cooperate to provide communication services satisfying particular semantics to application processes.

In a busy system that is involved in many network transactions, the processing to send and receive network data can occupy a significant fraction of the processor's time. Fortunately, much of the work of processing data packets can be parallelized and distributed among the processors (“CPUs”) of a multiprocessing system. Network interface hardware can also contribute to the “divide and conquer” strategy by placing received packets onto multiple queues, each of which can be processed by a separate CPU. However, support for multiple queues increases hardware complexity and cost, and each queue may require dedicated system resources such as memory pages. In addition, even with multiple queues, some parts of network data reception cannot be parallelized further, so additional techniques for improving processing efficiency are desirable.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a block diagram of a computing system that can implement an embodiment of the invention.

FIG. 2 is a flow chart describing network data reception and processing according to an embodiment of the invention.

FIG. 3 is a flow chart describing network connection establishment according to another embodiment of the invention.

### DETAILED DESCRIPTION

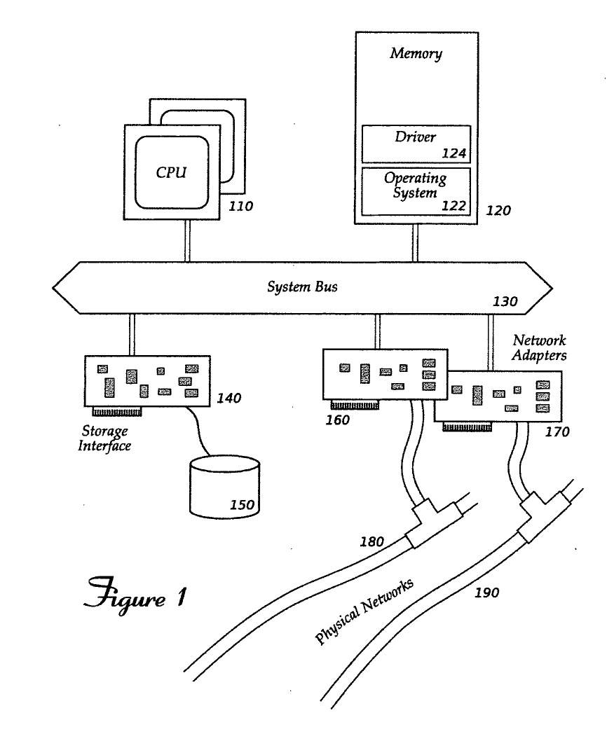

Computing systems that can apply and benefit from an embodiment of the invention may be similar to the one depicted in the block diagram of FIG. 1. The system contains a number of components or subsystems that cooperate under control of software to perform a variety of tasks, including network communication. It might contain several processors (“CPUs”) 110 (two CPUs are shown in this figure); memory 120; a storage interface 140 to communicate with a mass storage device such as disk 150; and network adapters (also known as a “network interface card” or “NIC”) 160 and 170 to exchange data with other systems connected to physical networks 180 and 190. These components are connected by, and can communicate with each other, over a system bus 130, which might be a Peripheral Component Interconnect (“PCI”) bus, a Peripheral Component Interconnect extended (“PCI-X”) bus, a PCI-Express bus, or other similar bus. Some CPUs contain two or more independent processors or “cores” within a single package. Although the cores may share certain internal subsystems, for most purposes they can be treated the same as completely independent CPUs. An operating system (“OS”) 122 typically controls the overall operation of the system, coordinating various software and hardware tasks so that the system's resources can be used efficiently. Portions of an embodiment of the invention may be incorporated in driver software 124 and in hardware or firmware on network adapters 160 and 170.

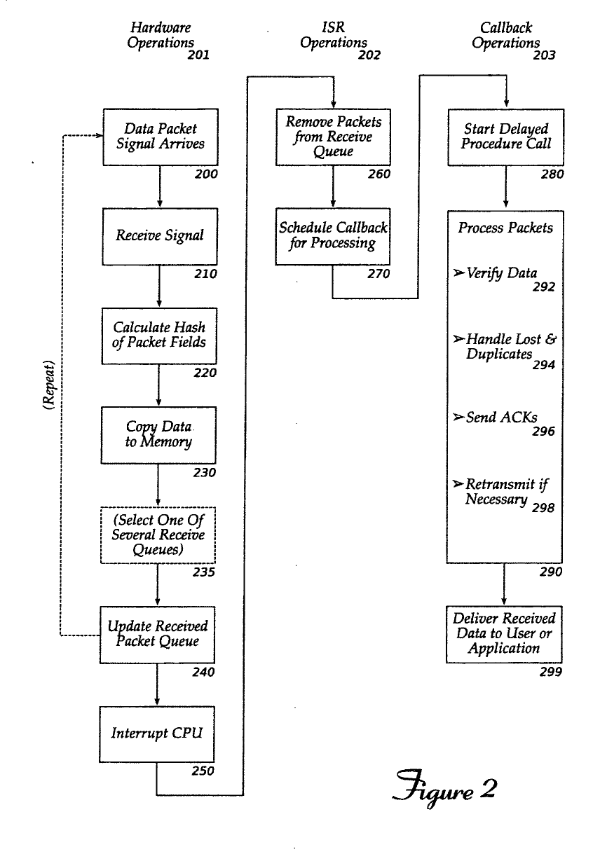

FIG. 2 describes the processes involved in receiving data over a network and delivering a portion of the data to an end user or application. The tasks are divided into Hardware Operations, 101, that are typically performed by the network adapter hardware; Interrupt Service Routine (“ISR”) Operations, 102, that are often performed asynchronously by a CPU executing instructions in response to an interrupt signal; and Callback Operations, 103, that are performed synchronously in one or more processes scheduled by the operating system. Although the tasks are often divided as shown, embodiments of the invention may be applied even when certain tasks are performed in a different order or by a different portion of hardware or software.

First, a signal representing a data packet arrives over the physical network (200). The network interface receives the signal (210) and converts it to a representation that can be manipulated by the computer system (for example, a block of binary digits). A hash value for the packet is computed over certain packet fields (220). The fields may be selected so that the hash can be used to group packets flowing between a particular sending machine and receiving machine, or between individual sending and receiving applications. In some systems, the Toeplitz hash function may be used. In other systems, alternate hash functions may provide a preferable combination of cryptographic security, ease of calculation, and compatibility with other system components.

Next, the data is copied to memory (230) and counters or pointers, such as a received data queue, may be updated (240) SO that the data can be located for later processing. Network adapters that implement multiple receive queues may select one of the queues (235), perhaps based on the previously-calculated hash value, before manipulating the queue to contain the newly-received packet.

After one or more packets are received and queued, the NIC interrupts one of the CPUs (250) to trigger further processing of the packet(s). The precise timing of the interrupt may vary according to an interrupt moderation scheme implemented by the NIC. For example, the NIC may interrupt when a certain number of packets have been queued, or when a certain number of data bytes have been received. Alternatively, the NIC may interrupt when the oldest packet on the queue reaches a certain age, or it may simply interrupt as soon as a packet has been received and queued.

In systems where the number of CPUs exceeds the number of queues, the selection of a CPU to interrupt takes on special significance, discussed below.

The interrupted CPU will begin to execute a sequence of instructions called an interrupt service routine (“ISR”). Code in an ISR may not have access to the full range of services and resources available from the operating system, and in any case, because an ISR executes asynchronously, it can disturb the OS's load balancing efforts by “stealing” time from a process that the OS had intended to allow to run. For these reasons, ISRs are usually designed to execute quickly, often merely acknowledging the interrupt and scheduling work to be performed later, synchronously, at a time chosen by the operating system.

Here, the ISR is likely to remove the packets from the receive queue (260) and schedule one or more delayed procedure calls or other callbacks (270), during which protocol processing will be performed for the packets. Some systems will process all the received packets within one callback, while others may process groups of packets in separate callbacks, or even process each packet in a separate callback. Systems operating according to some embodiments of the invention will separate the packets on the queue into two or more disjoint subsets and process the subsets in an equal number of callback functions, one executing on the interrupted CPU, and others executing on other CPUs.

Note that the expression “delayed procedure call” (“DPC”) is sometimes used to refer to a specific type of processing available in some Windows™ operating systems produced by Microsoft Corporation of Redmond, Wash. Other operating systems may offer similar task-scheduling functionality under different names. Another common name is simply “callback.” Because “delayed procedure call” describes the desired scheduling semantics well, that term (or the acronym “DPC”) will be used to refer to the general process of scheduling work to be performed later, and not only to the delayed procedure calls in Windows™.

Some time after the ISR completes, the operating system will execute the DPC(s) (280), which will perform protocol processing on the received packets that were assigned to them (290). Such processing may include verifying packet data integrity (292), handling lost or duplicated packets (294), transmitting acknowledgements of correctly-received data (296), and/or retransmitting data that was not received correctly by the remote peer (298).

If the processed packets contain valid user or application data, the DPC will arrange for it to be delivered to the application (299).

As mentioned in relation to operation 235, the NIC may refer to the packet's hash value when directing the packet to one of the receive queues. If the hash value is calculated over properly-selected fields, this will ensure that all packets related to a single logical connection are placed on the same queue. Similarly, when the ISR separates packets into disjoint subsets for processing on the CPUs available to handle the packets on the queue, the hash value can be used to avoid splitting packets for a single logical connection among several different CPUs.

Keeping packets from a connection together is important because many network protocols are highly optimized for in-order processing of packets. If packets from one connection were distributed among several processors, a lightly-loaded CPU might inadvertently process a later-received packet before an earlier-received packet that was assigned to a slower, heavily-loaded CPU, and thereby trigger time-consuming fallback and retransmission operations.

Returning to the issue mentioned in paragraph [0013], when several CPUs are available to process the packets on one network queue, which CPU should the NIC interrupt when the packets on the queue are to be processed? Recall that the ISR examines the packets and their hash values as it groups the packets and assigns the groups for processing by a delayed procedure call or callback. In making this examination, the interrupted CPU that executes the ISR may load information from (or about) each packet into its cache. The cached information may permit that CPU to perform other operations on those packets more quickly. The cache is said to be “warmed” for those packets; making a pass through the queued packets has a “cache warming” effect. If the interrupted CPU later executes one of the scheduled DPCs to process a group of packets, it may be able to process them faster than a CPU whose cache has not been warmed.

Therefore, the NIC should select and interrupt the CPU that can benefit most from the cache warming that occurs as the ISR processes the receive queue and schedules DPCs to perform further protocol processing. As a simple example, the NIC could count the number of packets that will be assigned to each CPU (according to their hash values) and interrupt the CPU that will eventually be called upon to execute the DPC to process the largest number of packets.

Another embodiment of the invention might count the number of data bytes in the packets assigned to each group, and interrupt the CPU that will eventually be called upon to process the group containing the most data. This selection method could result in the largest amount of data being processed and delivered to applications quickly.

In yet another embodiment, the NIC might count the number of packets of a certain type, or those containing a certain flag, and interrupt the CPU that will eventually be called upon to process the group containing the most packets of that type. For example, data packets of the Transmission Control Protocol (“TCP”) contain an acknowledge (“ACK”) flag, the receipt of which may permit the receiving system to send more data. If ACK packets are processed quickly, the logical connections to which the packets belong may be able to send pending data sooner, which may lead to overall improved throughput.

Other criteria may be useful in different systems employing embodiments of the invention. Generally speaking, the cache-warming effect of executing the interrupt service routine on a CPU can be thought of as a benefit or asset, which can be selectively bestowed on a CPU that will subsequently perform additional operations on some of the received packets. Embodiments of the invention choose the CPU where the benefit will best translate into a desirable performance attribute.

The principles explained above can be applied to improve network performance in another system configuration. Returning briefly to FIG. 1, observe that it is possible to connect both network interfaces (160 and 170) to the same physical network. This arrangement, sometimes called “teamed” interfaces, can permit the system to use a larger portion of the network's available bandwidth. Teamed network interfaces can load-share to distribute network traffic across the interfaces and CPUs and avoid overloading any single system component. Each NIC may implement multiple receive queues, and each receive queue may be serviced by more than one CPU, as described in the previous discussion of embodiments of the invention. For simplicity, the discussion of this multiple-adapter, teamed system will assume that each NIC has only one receive queue, and that inbound packets on each queue are to be processed by only one CPU.

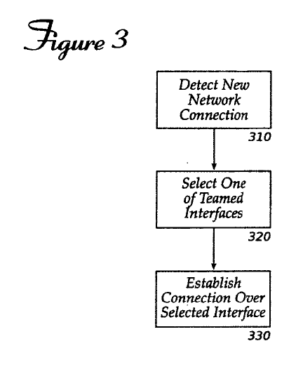

In a teamed network environment, an embodiment of the invention may operate according to the flow chart shown in FIG. 3. First, a new network connection is detected (310). The connection may be initiated by a process on the local machine sending a data packet appropriate for the desired protocol to a remote machine, or by a remote machine sending a similar packet to the local machine. One of the teamed interfaces is selected (320) and the new connection is established over the selected interface (330). Once the connection is established over the selected interface, network communication can proceed between the local system and its peer according to the methods discussed earlier. In particular, in the simple one-queue, one-CPU embodiment being considered, the first NIC in the team could interrupt a first CPU when its receive queue needed processing, and the second NIC in the team could interrupt a second CPU when its queue required service. Interrupting the appropriate CPU would extract the greatest benefit from the cache warming described earlier. If additional CPUs were available, they may be partitioned into distinct subsets and each interface (or each queue of each interface) may be configured to interrupt one of the CPUs in the subset associated with the interface or queue. The decision when to interrupt could be made as above: when the queue reaches a certain size, when the oldest packet on the queue reaches a certain age, or simply when a packet is received.

To select an interface, an embodiment of the invention could determine which of the team members had the lightest load, and establish the connection over that interface. Alternatively, an embodiment could calculate a hash value of an outgoing packet (for example, according to the Toeplitz hash, mentioned above, that is used in Microsoft Corporation's Receive-Side Scaling (“RSS”) system), and use the hash value to select the interface.

To cause an inbound connection to be established over a particular interface, an embodiment of the invention could respond to an Address Resolution Protocol (“ARP”) packet with a hardware address of the selected interface. ARP packets are often involved in the process of network connection establishment, and the protocol can be used to direct the network peer to communicate over a specific hardware device. Other interface types and communication protocols may permit alternate methods of directing inbound connections to a specific interface.

Various methods exist to direct a device interrupt such as a NIC interrupt to a specific one of the CPUs in a multiprocessor system. These methods often depend on the system hardware, interface type, and other variables. By way of example, devices that connect to a system through the widely-used Peripheral Component Interconnect (“PCI”) bus may implement Message Signaled Interrupts (“MSI-X”), which include the ability to specify the CPU to which an interrupt should be directed. Other interface types may provide similar ways to interrupt a particular processor.

An embodiment of the invention may be a machine-readable medium having stored thereon instructions which cause the processors of a multiprocessor system to perform operations as described above. In other embodiments, the operations might be performed by specific hardware components that contain hardwired logic. Those operations might alternatively be performed by any combination of programmable components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

The applications of the present invention have been described largely by reference to specific examples and in terms of particular allocations of functionality to certain hardware and/or software components. However, those of skill in the art will recognize that the network performance benefits described can also be produced by software and hardware that distribute the functions of embodiments of this invention differently than herein described. Such variations and implementations are understood to be apprehended according to the following claims.

We claim:

1. A method comprising:
receiving a plurality of packets over one network interface;
queuing each packet of the plurality of packets onto one receive queue, the receive queue to contain packets to be processed on a plurality of processors of a multiprocessor system;
selecting a first processor from among the plurality of processors; and
interrupting the first processor.

2. The method of claim 1, further comprising:
separating the plurality of packets on the receive queue into a plurality of disjoint subsets through operations performed by the first processor; and
scheduling a callback to process each disjoint subset of the plurality of disjoint subsets; wherein
at least one callback is to be executed by a second, different processor of the plurality of processors.

3. The method of claim 1, wherein selecting a first processor comprises:
counting a number of packets on the receive queue that are to be processed by each of the plurality of processors; and
selecting a processor that is to process a greatest number of packets as the first processor.

4. The method of claim 1, wherein selecting a first processor comprises:
calculating a total size in bytes of packets on the receive queue that are to be processed by each of the plurality of processors; and
selecting a processor that is to process a greatest number of bytes as the first processor.

5. The method of claim 1, wherein selecting a first processor comprises:
counting a number of packets of a predetermined type on the receive queue that are to be processed by each of the plurality of processors; and
selecting a processor that is to process a greatest number of packets of the predetermined type as the first processor.

6. The method of claim 1, wherein selecting the first processor comprises:
separating the plurality of packets on the receive queue into a plurality of disjoint subsets;
determining a size of each of the plurality of subsets; and
selecting as the first processor a processor that is to process a largest subset of the plurality of subsets.

7. A method comprising:
detecting a new network connection;
selecting one of a plurality of network interfaces to support the new network connection; and
establishing the new network connection over the selected one of the plurality of network interfaces; wherein
the plurality of network interfaces form a load-sharing team; and
each network interface of the plurality of network interfaces is to interrupt one of a distinct subset of a plurality of processors if the network interface receives a data packet.

8. The method of claim 7 wherein selecting one of the plurality of network interfaces comprises:
using a receive-side scaling (RSS) hash of an outgoing packet to select one of the plurality of network interfaces.

9. The method of claim 7 wherein establishing the new network connection over the selected one of the plurality of network interfaces comprises:
responding to an address resolution protocol (ARP) request with a hardware address of the selected one of the plurality of network interfaces.

10. A machine-readable medium containing instructions that, when executed by a programmable machine, cause the programmable machine to perform operations comprising:
calculating a hash value for each packet of a plurality of packets;
maintaining a queue to contain the plurality of packets;
selecting a processor from among a plurality of processors of a multiprocessor system; and
interrupting the selected processor.

11. The machine-readable medium of claim 10, containing instructions to cause the programmable machine to perform operations comprising:
counting a number of packets of the plurality of packets that are to be processed by each processor of the plurality of processors; wherein
selecting a processor is selecting a processor that is to process a largest number of packets.

12. The machine-readable medium of claim 10, containing instructions to cause the programmable machine to perform operations comprising:
calculating a size in bytes of the plurality of packets that are to be processed by each processor of the plurality of processors; wherein
selecting a processor is selecting a processor that is to process a largest number of bytes.

13. The machine-readable medium of claim 10, containing instructions to cause the programmable machine to perform operations comprising:
counting a number of packets of a predetermined type among of the plurality of packets that are to be processed by each processor of the plurality of processors; wherein
selecting a processor is selecting a processor that is to process a largest number of packets of the predetermined type.

14. A system comprising:
a plurality of processors; and
a network interface having a plurality of receive queues; wherein
each receive queue is associated with a plurality of processors; and
the network interface is to interrupt a selected one of the plurality of processors associated with a receive queue if at least one packet is on the receive queue.

15. The system of claim 14 further comprising an interrupt service routine (ISR) to process a receive queue, wherein:
processing the receive queue comprises assigning each packet on the receive queue to one of the plurality of processors; and
scheduling a callback to cause an assigned processor of the plurality of processors to process the packet.

16. The system of claim 14, further comprising selection logic to track a contents of a receive queue and to select a processor of the plurality of processors.

17. The system of claim 16 wherein the selection logic comprises:
a counter to count a number of packets on the receive queue that are to be processed by each one of the plurality of processors; and
a selector to select a one of the plurality of processors that is to process a largest number of packets on the receive queue.
